(19) United States
(12) Patent Application Publication
(10) Pub. No.: US 2016/0372067 A1
(43) Pub. Date: Dec. 22, 2016

(54) Display Device and Related Power Supply Module

(71) Applicant: Sitronix Technology Corp., Hsinchu County (TW)

(72) Inventors: Tsun-Sen Lin, Hsinchu County (TW); Min-Nan Liao, Hsinchu County (TW)

(21) Appl. No.: 14/841,718

(22) Filed: Sep. 1, 2015

(30) Foreign Application Priority Data
Jun. 22, 2015 (TW) 104119948

(51) Int. Cl. G09G 3/36

(52) U.S. Cl. CPC G09G 3/3648

(57) ABSTRACT

A display device includes a plurality of driving units configured along with a first axis; and a plurality of power supplying units configured along with the first axis for generating a plurality of power signals, wherein each of the plurality of power signals is coupled to at least one of the plurality of driving units.

### BACKGROUND OF THE INVENTION

1. Field of the Invention

The present invention relates to a display device and related power supply module, and more particularly, to a display device with power supply units configured along with a first axis and related power supply module.

2. Description of the Prior Art

A liquid crystal display (LCD) is a flat panel display which has the advantages of low radiation, light weight and low power consumption and is widely used in various information technology (IT) products, such as notebook computers, personal digital assistants (PDA), and mobile phones. An active matrix thin film transistor (TFT) LCD is the most commonly used transistor type in LCD families, especially in the large-size LCD family. A driving system installed in the LCD, includes a timing controller, source drivers and gate drivers. The source and gate drivers respectively control data lines and scan lines, which intersect to form a cell matrix. Each intersection is a cell including crystal display molecules and a TFT. In the driving system (e.g. a driving integrated circuit (IC)), the gate drivers are responsible for transmitting scan signals to gates of TFTs to turn on the TFTs on the panel. The source drivers are responsible for converting digital image data, sent by the timing controller, into analog voltage signals and outputting the voltage signals to sources of the TFTs. When the TFT receives the voltage signals, a corresponding liquid crystal molecule has a terminal whose voltage changes to equalize the drain voltage of the TFT, and thereby changes its own twist angle. The rate that light penetrates the liquid crystal molecule is changed accordingly, and thus different colors can be displayed on the panel.

As technology advances, the resolutions of the liquid crystal display gradually increases (e.g. increases from full high definition (HD) to 4K) and the image quality of the liquid crystal display is also improved. When the resolution of the liquid crystal display increases, the number of components in the driving device used for driving the display panel also increases. Generally, the power suppliers used for providing powers are configured in the same area and provide the powers to circuits in the driving device (e.g. gate drivers and source drivers) via conducting lines. When the number of the circuits in the driving device increases and/or the current consumptions of the circuits in the driving device rise, however, the resistances on the conducting lines of providing powers generate significant voltage drops. The voltages of powers received by the circuits in the driving device vary with the distances between each of circuits and the area of the power suppliers. Under such a condition, the circuit distant from the area of the power suppliers may work abnormally. Thus, how to reduce the differences among the voltages of the powers outputted to the circuits in the driving device becomes a topic to be discussed.

### SUMMARY OF THE INVENTION

In order to solve the above problem, the present invention provides a display device having power supply units configured along with a first axis and related power supply module.

The present invention discloses a display device. The display device comprises a plurality of driving units, configured along with a first axis; and a plurality of power supplying units, configured along with the first axis for generating a plurality of power signals, wherein each of the plurality of power signals is coupled to at least one of the plurality of driving units.

The present invention further discloses a power supply module for a display device comprising a plurality of driving units configured along with a first axis. The power supply module comprises a plurality of power supply unit, configured along with the first axis for generating a plurality of power signals, wherein each of the plurality of power signals is coupled to at least one of the plurality of driving units.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a display device according to an example of the present invention.

FIG. 2 is a schematic diagram of another display device according to an example of the present invention.

FIG. 3 is a schematic diagram of another display device according to an example of the present invention.

FIGS. 4A and 4B are schematic diagrams of a power supply unit according to an example of the present invention.

FIG. 5 is a schematic diagram of another display device according to an example of the present invention.

FIG. 6 is a schematic diagram of another display device according to an example of the present invention.

FIG. 7 is a schematic diagram of another display device according to an example of the present invention.

### DETAILED DESCRIPTION

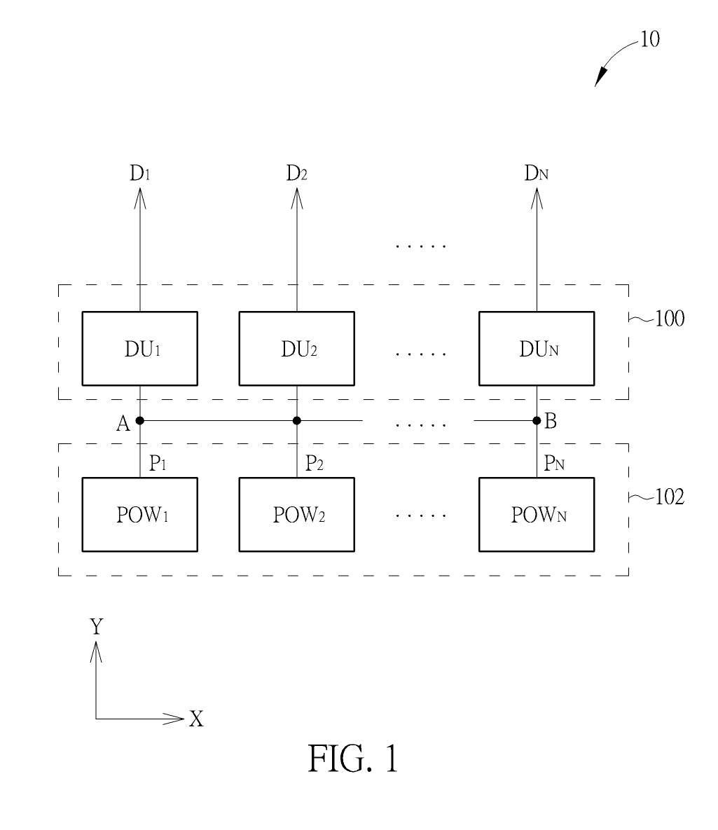

Please refer to FIG. 1, which is a schematic diagram of a display device 10 according to an example of the present invention. The display device 10 may be an electronic product with a display panel, such as a smart phone, a tablet, a television a notebook computer, or a driving circuit for driving the display panel. In FIG. 1, the display device 10 comprises the driving module 100 and power supply module 102. The components not directly relating to the concept of the present invention (e.g. the housing, the display pixel array, and the timing controller) are not shown in FIG. 1 for brevity. The driving module 100 is the driving circuit utilized for driving display components in the display device 10 (e.g. the source driver and the gate driver), and is not limited herein. As shown in FIG. 1, the driving module 100 comprises a plurality of driving units DU₁-DU_{N} that are utilized for generating a plurality of driving signals D₁-D_{N}. The power supply module 102 comprises a plurality of power supply units POW₁-POW_{N} that are utilized for providing power signals P₁-P_{N} to the driving units DU₁-DU_{N}. In this example, the driving units DU₁-DU_{N} are configured along with a first axis (i.e. X axis) and the power supply units POW₁-POW_{N} are also configured along with the X axis. Via adopting the configuration method of the power supply units POW₁-POW_{N} shown in FIG. 1, the differences among the power signals received by the driving units DU₁-DU_{N} are shrunk. The driving units DU1-DUN avoid working abnormally, therefore.

In detail, the circuit layout of the display device 10 is required to configured the driving units DU₁-DU_{N} along with the X-axis because of the hardware feature of the display device 10, resulting that the length of the driving module 100 in the X-axis direction is significantly greater than the height of the driving module 100 in the Y-axis direction. For example, the length of the driving module 100 in the X-axis direction may be at least 5-10 times the height of the driving module 100 in the Y-axis direction. Under such a condition, if the power supply module 102 only provides power signal at a node A shown in FIG. 1, a significant voltage drop exists between the power signal received by the driving unit DU₁ and that received by the driving unit DU_{N}. That is, the significant voltage drop exists between the power signal received by the driving unit DU₁ and that received by the driving unit DU_{N} if the power supply module 102 does not utilize the power supply units POW₂-POW_{N} to provide the power signals P₂-P_{N}, and the driving unit DU_{N} may work abnormally. Similarly, if the power supply module 102 only provides power signal at a node B shown in FIG. 1, a significant voltage drop also exists between the power signal received by the driving unit DU₁ and that received by the driving unit DU_{N}.

In order to reduce the differences among the power signals received by the driving units DU₁-DU_{N}, the power supply module 102 equips with the plurality of power supply units POW₁-POW_{N} that are uniformly configured along with the X-axis in the circuit layout. The power supply units POW₁-POW_{N} generate power signals P₁-P_{N}, respectively, to the driving units DU₁-DU_{N}. The power signals P₁-P_{N} are connected to each other. Via uniformly configuring the power supply units POW₁-POW_{N} along with the X-axis (in the circuit layout), the voltage differences among the power signals received by the driving units DU₁-DU_{N} are shrunk, so as to prevent the driving units DU₁-DU_{N} from working abnormally.

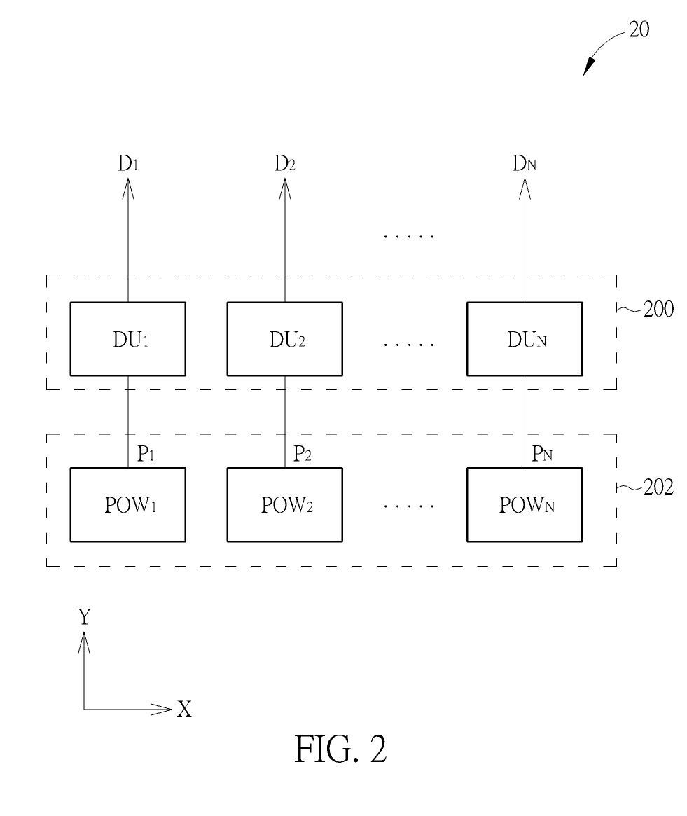

Please refer to FIG. 2, which is a schematic diagram of a display device 20 according to an example of the present invention. The display device 20 may be an electronic product with a display panel, such as a smart phone, a tablet, a television a notebook computer, or a driving circuit for driving the display panel. The display device 20 is similar to the display device 10 shown in FIG. 1, thus the components and signals with similar functions use the same symbols. Different from the display device shown in FIG. 1, the power signals P₁-P_{N} generated by the power supply units POW₁-POW_{N} of the display device 20 are not coupled to each other. In other words, the power supply units POW₁-POW_{N} are uniformly configured along with the X-axis in the circuit layout of the display device 20 and provide the power signals P₁-P_{N} to the driving units DU₁-DU_{N}, separately. Since the power signals P₁-P_{N} do not affect to each other, the designs of the power supply units POW₁-POW_{N} can be altered according to specifications of the driving units DU₁-DU_{N}.

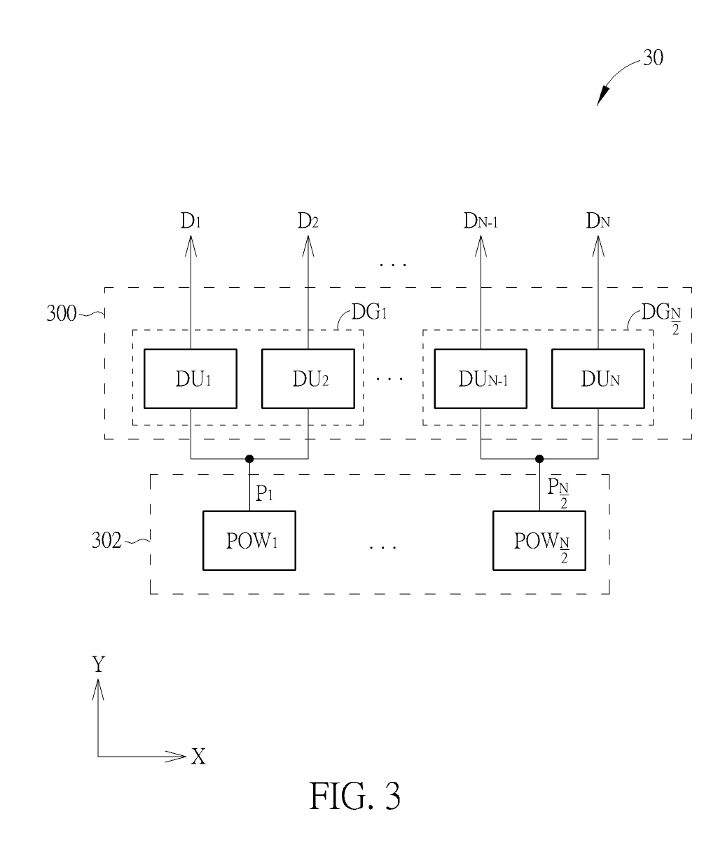

In an example, the driving units DU₁-DU_{N} are classified into different driving groups, wherein the driving units in the same driving group use the same power signal. The number of the power supply units is reduced, therefore. Please refer to FIG. 3, which is a schematic diagram of a display device 30 according to an example of the present invention. The display device 30 may be an electronic product with a display panel, such as a smart phone, a tablet, a television a notebook computer, or a driving circuit for driving the display panel. The display device 30 is similar to the display device 20 shown in FIG. 2, thus the components and signals having similar functions use the same symbols. In this example, the driving units DU₁ and DU₂ that are adjacent in the circuit layout are classified into a driving group DG₁ and jointly use the power signal P₁ generated by the power supply unit POW₁; the driving units DU₃ and DU₄ (not shown in FIG. 3) that are adjacent in the circuit layout are classified into a driving group DG₂ (not shown in FIG. 3) and jointly use the power signal P₂ generated by the power supply unit POW₂; and so on. In comparison with the number of the power supply units in the display devices 10 and 20, the number of the power supply units in the display device 30 is decreased to N/2.

Via configuring the plurality of power supply units along with the first axis (the X-axis) in the circuit layout of the display device, the above examples make the differences among the power signals received by the plurality of driving units shrunk, to avoid the plurality of driving units working abnormally. According to different applications and design concepts, those with ordinary skill in the art may observe appropriate alternations and modifications.

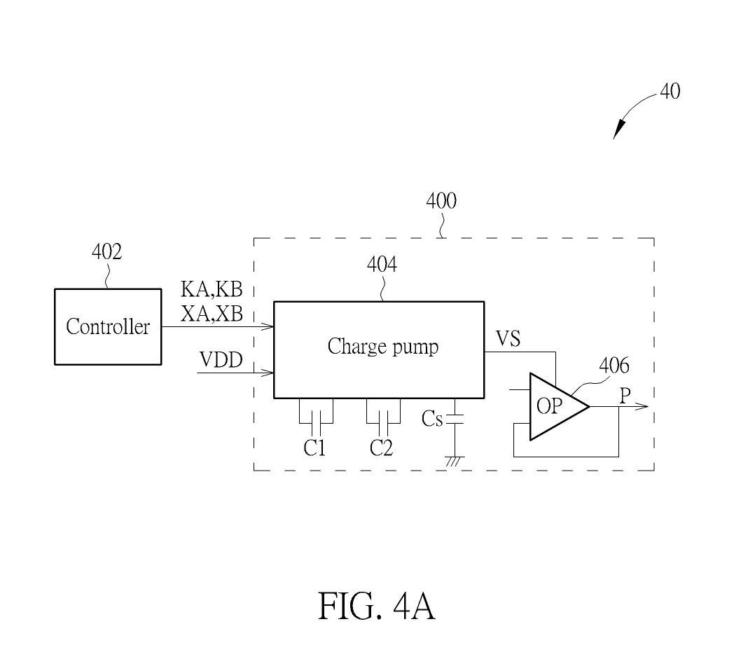

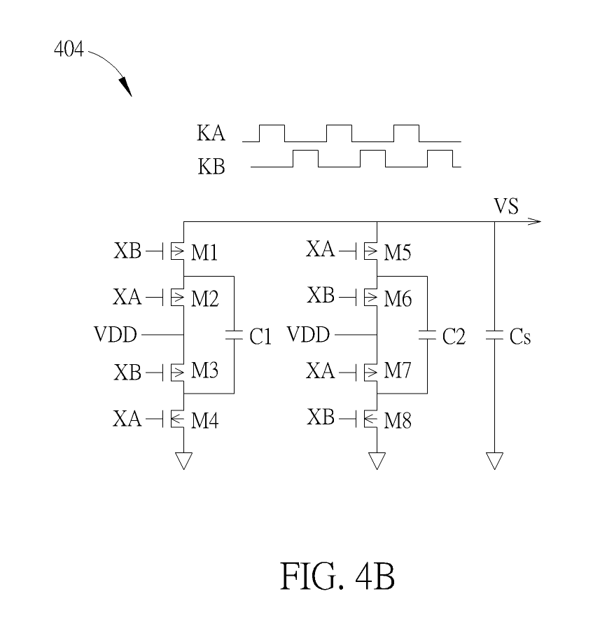

For example, the power supply module 102 may be realized in various structures. Please refer to FIGS. 4A and 4B, wherein FIG. 4A is a schematic diagram of a power supply unit 40 and FIG. 4B is a schematic diagram of a charge pump 404 shown in FIG. 4A. The power supply unit 40 may be one of the power supply unit POW₁-POW_{N} shown in FIGS. 1-3. As show in FIGS. 4A and 4B, the power supply unit 40 comprises a power supplier 400 and a controller 402. The power supplier 400 is composed of the charge pump 404 and an amplifier 406. The controller 402 is utilized for generating conducting signals KA, KB, XA, and XB, wherein the conducting signal XA is the inverse signal of the conducting signal KA and the conducting signal XB is the inverse signal of the conducting signal KB. The charge pump 404 comprises transistor switches M1-M8, flying capacitors C1 and C2, and a storage capacitor Cs. The charge pump 404 conducts the transistor switches M1-M8 according to the conducting signals KA, KB, XA, and XB, to charging the flying capacitors C1 and C2 via a voltage VDD and to output a charging voltage VS. Next, the amplifier 406 use the charging voltage VS as a voltage source, to generate and to output an amplified voltage as the outputted power signal P.

According to different applications and design concepts, the power supply unit 40 may be appropriately altered and modified. In an example, the amplifier 406 is omitted and the power supplier 400 outputs the charging voltage VS generated by the charge pump 404 as the power signal P (i.e. one of the power signals P₁-P_{N} outputted by the power supply units POW₁-POW_{N}). In another example, the controller 402 is omitted and the conducting signals KA, KB, XA, and XB are provided by other circuits of the display device. In still another example, the controller 402 and the amplifier 406 are omitted. The conducting signals KA, KB, XA, and XB are provided by other circuits of the display device and the power supplier 400 outputs the charging voltage VS generated by the charge pump 404 as the power signal P.

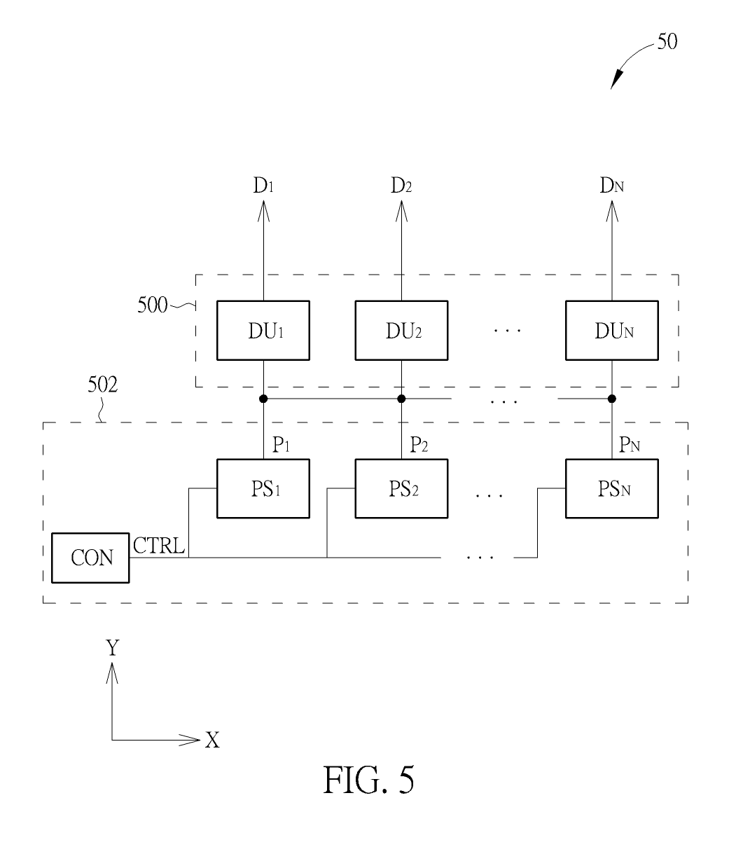

Please refer to FIG. 5, which is a schematic diagram of a display device 50 according to an example of the present invention. The display device 50 may be an electronic product with a display panel, such as a smart phone, a tablet, a television a notebook computer, or a driving circuit for driving the display panel. The display device 50 is similar to the display device 10 shown in FIG. 1, thus the components and signals with similar functions use the same symbols. In this example, the power supply module 502 comprises a plurality of power suppliers PS₁-PS_{N} and a controller CON. For example, the power suppliers PS₁-PS_{N} are the power supplier 404 shown in FIG. 4A and the power suppliers PS₁-PS_{N} are jointly controlled by a control signal CTRL generated by the controller CON (e.g. the conducting signals KA, KB, XA, and XB shown in FIGS. 4A and 4B). Via configuring the power suppliers PS₁-PS_{N} along with the X-axis (in the circuit layout), the differences between among the power signals received by the driving units DU₁-DU_{N} are shrunk. The driving units DU₁-DU_{N} avoid working abnormally, therefore.

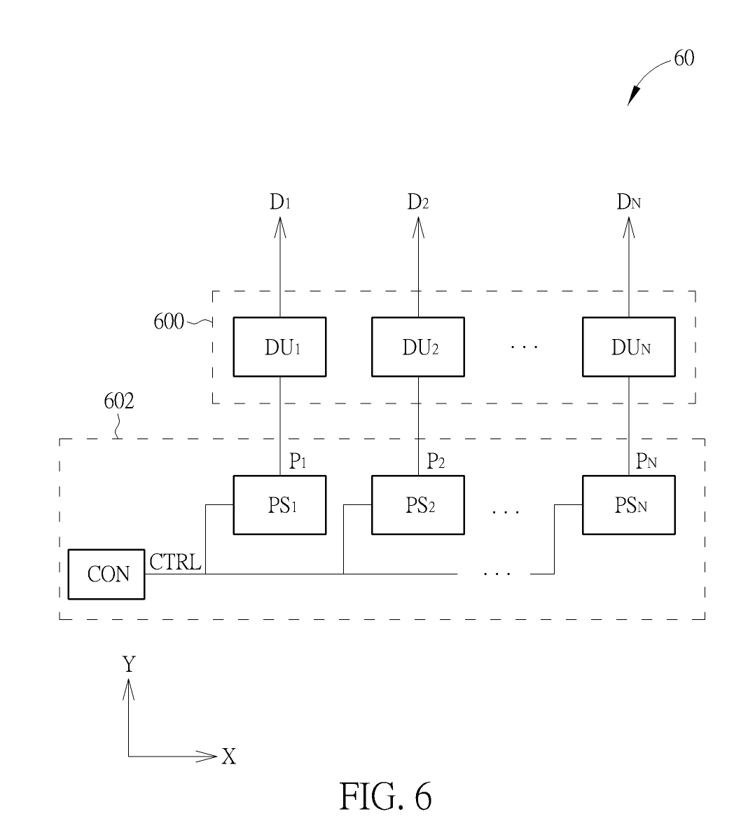

Please refer to FIG. 6, which is a schematic diagram of a display device 60 according to an example of the present invention. The display device 60 may be an electronic product with a display panel, such as a smart phone, a tablet, a television a notebook computer, or a driving circuit for driving the display panel. The display device 60 is similar to the display device 50 shown in FIG. 5, thus the components and signals with similar functions use the same symbols. In the example, the power supply module 602 is also composed of a plurality of power suppliers PS₁-PS_{N} and a controller CON. Different from the power signals P₁-P_{N} in the display device 50 shown in FIG. 5, the power signals P₁-P_{N} generated by the power suppliers PS₁-PS_{N} do not couple to each other in the display device 60. In other words, the power suppliers PS₁-PS_{N} that are uniformly configured along with the X-axis in the circuit layout provide the power signals P₁-P_{N} to the driving units DU₁-DU_{N}, separately. Since the power signals P₁-P_{N} do not affect to each other in this example, the designs of the power suppliers PS₁-PS_{N} can be altered according to specifications of the driving units DU₁-DU_{N}.

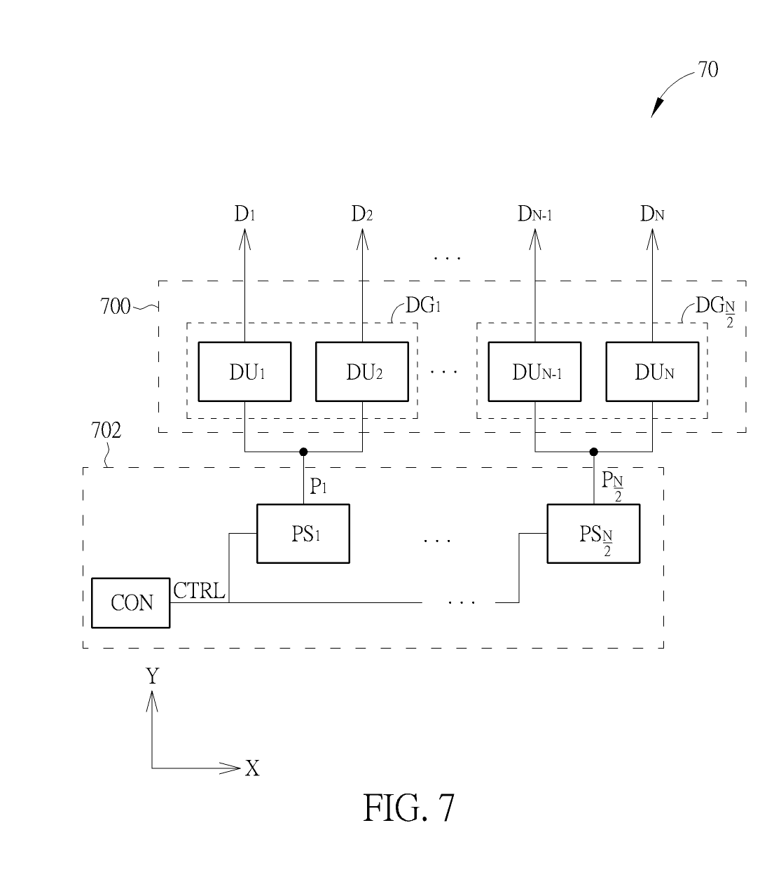

Please refer to FIG. 7, which is a schematic diagram of a display device 70 according to an example of the present invention. The display device 70 may be an electronic product with a display panel, such as a smart phone, a tablet, a television a notebook computer, or a driving circuit for driving the display panel. The display device 70 is similar to the display device 60 shown in FIG. 6, thus the components and signals with similar functions use the same symbols. In the example, the power supply module 702 is also composed of a plurality of power suppliers

$${PS}_{1} - {PS}_{\frac{N}{2}}$$

and a controller CON. The driving units DU₁ and DU₂ that are adjacent in the circuit layout are classified into a driving group DG₁ and jointly use the power signal P₁ generated by the power supplier PS₁; the driving units DU₃ and DU₄ (not shown in FIG. 7) that are adjacent in the circuit layout are classified into a driving group DG₂ (not shown in FIG. 7) and jointly use the power signal P₂ generated by the power supplier PS₂; and so on. In comparison with the number of the power supply units in the display devices 50 and 60, the number of the power supply units in the display device 70 is decreased to N/2.

The above examples decrease the difference among the power signals received by the plurality of driving units that are configured along with the first axis (e.g. the X-axis) in the circuit layout via configuring the plurality of the power supply units along with the first axis in the circuit layout, to prevent the plurality of driving units from working abnormally.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A display device, comprising:
a plurality of driving units, configured along with a first axis; and
a plurality of power supplying units, configured along with the first axis for generating a plurality of power signals, wherein each of the plurality of power signals is coupled to at least one of the plurality of driving units.

2. The display device of claim 1, wherein the plurality of power signals are coupled to each other.

3. The display device of claim 1, wherein each of the plurality of power signals is coupled to one of the plurality of driving units.

4. The display device of claim 1, wherein each of the plurality of power signals is coupled at least two adjacent driving units among the plurality of driving units.

5. The display device of claim 1, wherein each of the plurality of power supply units comprises:
a power supplier, for generating one of the plurality of power signals according to a power control signal; and
a controller, for generating the power control signal.

6. The display device of claim 1, wherein each of the plurality of power supply unit generates one of the plurality of power signals according to a power control signal and the display device comprises a controller to generate the power control signal.

7. A power supply module for a display device comprising a plurality of driving units configured along with a first axis, the power supply module comprising:
a plurality of power supply unit, configured along with the first axis for generating a plurality of power signals, wherein each of the plurality of power signals is coupled to at least one of the plurality of driving units.
